(19) United States
(12) Patent Application Publication
(10) Pub. No.: US 2018/0260557 A1
(43) Pub. Date: Sep. 13, 2018

(54) SYSTEM AND METHOD FOR MANAGING AND UPDATING PASSWORDS TO ONLINE SERVICES

(71) Applicant: Paul Alexander Rockwell, Los Gatos, CA (US)

(72) Inventor: Paul Alexander Rockwell, Los Gatos, CA (US)

(21) Appl. No.: 15/456,524

(22) Filed: Mar. 12, 2017

(51) Int. Cl. G06F 21/46; H04L 29/06; H04L 9/08

(52) U.S. Cl. CPC G06F 21/46; H04L 63/083; H04L 9/3226; H04L 9/0891; H04L 9/0861

(57) ABSTRACT

A method, an apparatus, and a computer program product for managing a set of passwords for online services. The apparatus determines a current set of passwords associated with the user for the online services. The apparatus determines at least one criterion that excludes user intervention for refreshing passwords to the remote systems. The apparatus detects at least one trigger condition matching the at least one criterion that excludes user intervention for refreshing the passwords to the remote systems. Upon detecting the at least one criterion condition, generating a new set of passwords and transmitting at least one command including the new set of passwords to the remote systems.

### BACKGROUND

### Field

The present disclosure relates to the fields of computer program security, user access control, user interface methods, and online authentication, and more particularly to the field of password management.

### Background

Online services and websites require users to supply a combination of user names and passwords for authorization, authentication, and access. With the proliferation of available services, it has become increasingly difficult for the average user to maintain the large number of user credentials including username and password combinations. The difficulty of maintaining the credentials has left some users resorting to using the same password or passwords for multiple services, or resorting to writing down passwords, which may be a security vulnerability. While merely maintaining the numerous login credentials is a difficult task, continually changing and updating the credentials has become and additional burden for users.

In addition, nefarious groups and organizations have become ever more proficient at compromising online systems. Once compromised, a system's password credentials may be used to compromise other systems. For example, some users may select the same password or password and username combination. Using the same password or password and username combination creates additional vulnerabilities for online systems because one compromised service may be used to compromise another system.

Accordingly, a need exists to improve the user experience and security of user authentication to the multiple online systems.

### SUMMARY

In an aspect of the disclosure, a method, a computer program product, and an apparatus are provided for managing a set of passwords for online services. The apparatus determines a current set of passwords associated with the user for the online services. The apparatus determines at least one criterion that excludes user intervention for refreshing passwords to the remote systems. The apparatus detects at least one trigger condition matching the at least one criterion that excludes user intervention for refreshing the passwords to the remote systems. Upon detecting the at least one criterion condition, generating a new set of passwords and transmitting at least one command including the new set of passwords to the remote systems.

### BRIEF DESCRIPTION OF THE DRAWINGS

The present disclosure is illustrated by way of example, and not by way of limitation, and may be more fully understood with reference to the following detailed description when considered in connection with the figures below.

FIG. 1 is a block diagram of an exemplary system architecture in which embodiments of the invention may operate.

FIG. 2 is an exemplary flow diagram illustrating a method for managing a set of passwords on one or more remote systems.

FIG. 3 is another exemplary flow diagram illustrated methods for method for managing a set of passwords on one or more remote systems.

FIG. 4 illustrates an exemplary apparatus in the form of a computer system, in accordance with embodiments of the disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Methods and systems for password management and authentication are described. The computing system may be a computing device (e.g., a computer, a laptop computer, a mobile device (phone), a wearable device, or any other suitable electronic apparatus) or a server. In one embodiment, authentication credentials associated with a user may be determined and updated automatically on various online systems without user intervention. The system may determine the credentials through direct input from the user, from preexisting files or caches (e.g., a password file), or from automatically or programmatically generating the credentials.

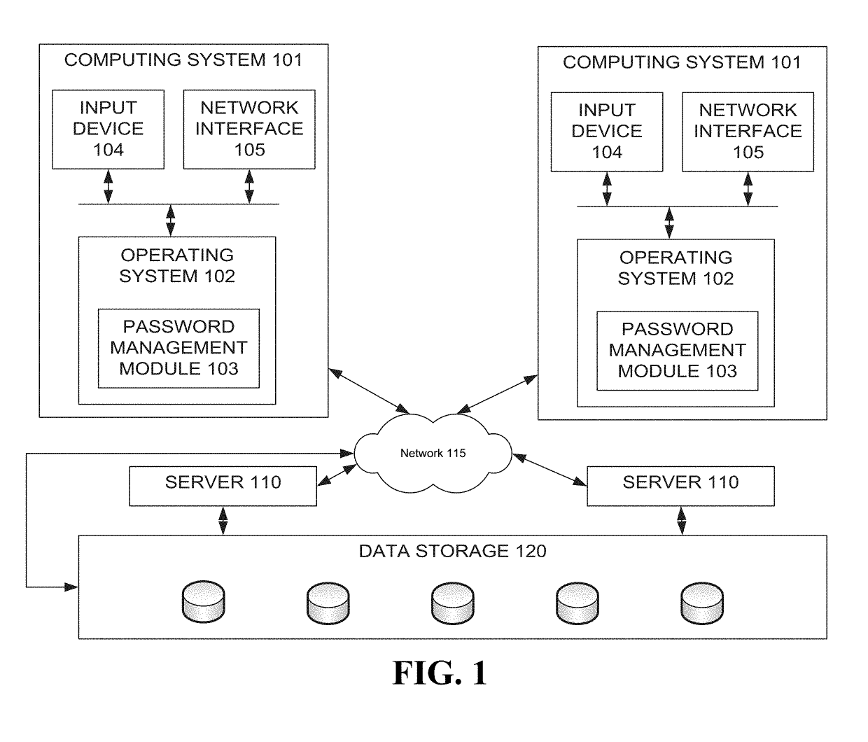

FIG. 1 illustrates an exemplary system architecture 100 in which embodiments of the present invention may operate. The system architecture 100 includes servers 110 coupled to computing systems 101 over a network 115. The servers 110 may be a personal computer (PC), laptop, a smart phone, tablet, a wearable device, or any machine capable of executing a set of instructions (sequential or otherwise) that specify actions to be taken by that machine. The network 115 may be a private network (e.g., a local area network (LAN), a wide area network (WAN), intranet, etc.), a corporate network (e.g., a private network for an organization such as a corporation), and/or a public network (e.g., the Internet). The servers 110 may be coupled to data storage 120. The data storage 120 may include one or more mass storage devices (e.g., disks), which form a storage pool shared by all the servers 110 and/or the computing systems 101. The data storage 120 may include files, emails, and/or data (e.g., sensitive information) which may be accessed by the computing system 101 and/or the servers 110.

In one embodiment the servers 110 may be authentication servers. An authentication server may authenticate user passwords and/or grant access to network resources (e.g., other servers) and/or network services. An authentication server may also provide an access ticket (e.g., a Kerberos Ticket Granting Ticket (TGT)) to a client (e.g., a computing system 101) after authentication of the user password. The access ticket (e.g., a TGT) may be used to access network locations, network resources, and/or network services. In another embodiment, the authentication server may be part of a Single Sign-On (SSO) system. In an SSO system, a user is generally authenticated by the authentication server and the authentication server grants access (e.g., via a TGT) to multiple devices, network resources, network locations, and/or network services, which use the SSO system for authentication. In will be readily apparent to one skilled in the art that other authentication methods may be used with the embodiments of the disclosure. For example, the disclosure is not limited to the Kerberos or SSO methods and systems. Other examples may include multi-factor authentication, public key or private key encryption, etc. Authorization, Authentication, and Access (AAA) servers may be used in various embodiments of the disclosure.

The computing systems 101 may include computing devices that have a wide range of processing capabilities such as a personal computer (PC), a server computer, a laptop computer, a smart phone, a wearable device, a network computer, a tablet device, and/or any machine capable of executing a set of instructions (sequential or otherwise) that specify actions to be taken by that machine. The computing system 101 may include an input device 104, a network interface 105, an operating system 102, and a password management module or system 103. While the password management module 103 is illustrated as a part of operating system 102, one skilled in the art will recognize that the password management module 103 may be stored and/or running on server 110. Password management module 103 may be a self-contained module coupled to or operating independent of computing system 101 (e.g., password management module 103 may be outside of operating system 102). For example, in some embodiments, password management module 103 may be an apparatus that receives and transmits information to and from computing system 101. In yet other embodiments, password management module 103 may run on a centralized server or a distributed system (such as a cloud computing system).

In one embodiment, the input device 104 may include hardware, software, and/or a combination of both. For example, the input device 104 may include, but is not limited to, one or more of a keyboard, a mouse, a touch pad, a touch screen, a card reader (e.g., a smart card reader, etc.), a USB interface (e.g., a USB interface to communicate with a USB token device, etc.), a wireless interface (e.g., a Bluetooth interface to communicate with a wireless token device, etc.), a biometric sensor (e.g., a heartrate monitor, a fingerprint scanner, an iris scanner, etc.) and/or software and drivers associated with the input device 104. In another embodiment, the input device 104 may be used to accept user input (e.g., accept user credentials). For example, the user may use a keyboard and a mouse to enter a username and/or user password. Although one input device 104 is shown for the computing system 101, in other embodiments, multiple input devices 104 may be present. For example, a keyboard, a mouse, a USB interface, a wireless interface, and a biometric sensor may all be in the computing system 101.

In one embodiment, the network interface 105 may be used by the computing system 101 to communicate with the network 115, the servers 110, and/or the data storage 120. For example, the computing system 101 may access data and applications located on the server 110 and/or data storage 120 using the network interface 105. In one embodiment, the network interface 105 may be used to communicate with an authentication server (e.g., one of the servers 110 may be an authentication server). The network interface 105 may be hardware, software, or a combination of both. For example, the network interface 105 may include, but is not limited to, a network interface card (NIC), a wireless network card, physical cables, and/or software and drivers associated with the network interface 105.

In one embodiment, the operating system 102 may manage hardware resources (e.g., peripheral devices such as a disc drive, input/output devices, memory, hard disk, etc.), software resources (e.g., drivers, system files, etc.) and may manage execution of applications.

The operating system 102 may include a password management module 103. In one embodiment the password management module 103 may manage user credentials. User credentials may include user names, biographical information, passwords, biometric information (e.g., finger, iris scan, or any other accessible biometric information from a person), a key (e.g., a cryptographic key), information for two or three factor authentication (e.g., access to email, phone, voicemail, etc.), digital certificate, etc. In the embodiments described, when a method or system uses a password, it will be recognized that any other combination of credentials may be used in addition or in the alternative to the password.

In another embodiment, the password management module 103 may generate a set of passwords for the user credentials. For example, based on one or more set of criteria (e.g., protocols, encryption algorithms, number or type of text character requirements, etc.) for the passwords, the password management module 103 may automatically generate the set of passwords. In some instances, the user may not desire to manually enter passwords himself. For example, in day-to-day usage, a user may interact with dozens of network servers or online services. The user may find it inconvenient not only to update the passwords, but to even generate such a large number of passwords. In this case, the password management module 103 may automatically produce these passwords without the intervention of the user. Many of the steps and processes containing herein may be performed without user intervention (e.g., no input, no prompts to the user, steps performed without any user interaction, etc.). Automatic generation may be beneficial because users may not produce random or sufficiently secure passwords. For example, users may tend to use the same letter or number combinations (e.g., birthdays, names of pets, etc.) for passwords. For example, users may have difficulty producing random numbers. An automatic method of procedure, on the other hand, may generate random and sufficiently secure passwords that may be based on quantifying random noise, and passwords without any traces of personal or biographic information. The password management module 103 may retrieve or generate other information for authentication. In some instances, the credential may be retrieved once and stored permanently (e.g., a fingerprint that does not change over a period of time), or the credential may be retrieved or generated continuously (e.g., an RSA key fob).

The password management module 103 may store the credentials in a data store contained within computing system 101 or coupled to computing system 101 (not shown). The credentials may be encrypted or stored by other secure means.

Trigger conditions may include a time, an elapse period, a number of logins, or a network trigger (e.g., a message included in a user profile). For example, the user profile may be a server side file that keeps track of the user preferences and server side attributes. The user profile may include one or more password algorithms (e.g., RSA, private key, public key, one-time scratch pads, etc.), an expiration time for the password, etc. When the user profile includes a password algorithm, the password management module 103 may generate a password based on the algorithm.

Password management module 103 may generate a set of new passwords based on the trigger condition. After the set of new passwords are generated, computing system 101 may update all network systems with the new passwords. The manage system may include reading the cache file to determine whether there is a need to update the password; the system may include a delay for updating the passwords based on a time or time period. In some embodiments, the password update may be triggered manually, e.g., by the user or a system administrator.

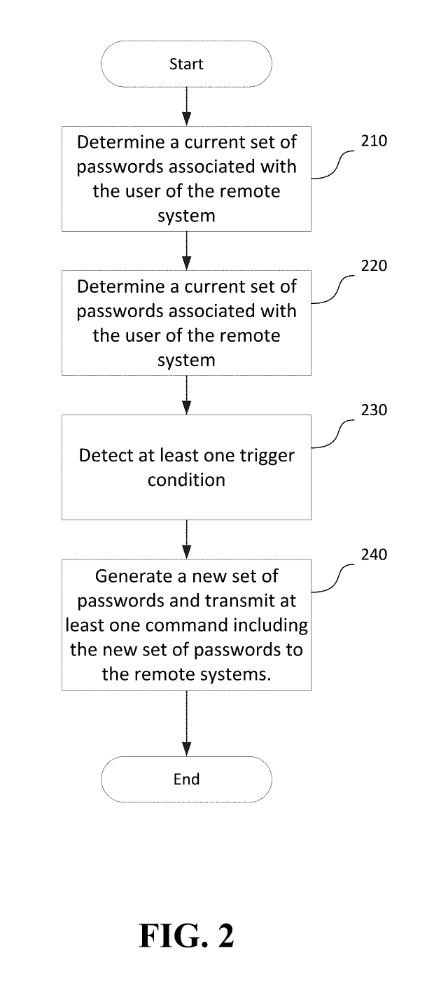

FIG. 2 is a flowchart of an exemplary embodiment. The method in FIG. 2 may be performed by a computing system, such as computing system 101. The method may be methods of password management module 103. Starting at 210, the system may determine a current set of passwords associated with the user of the remote systems. The remote systems may include server used for password management. In some cases, the remote systems may include an authentication, authorization, and accounting (AAA) server, a terminal access controller access control system plus server (TACACS+), or a remote authentication dial-in user service (RADIUS) server. At step 220, the system may determine at least one criterion that excludes user intervention for refreshing passwords to the remote systems. At step 230, the system detects at least one trigger condition matching at least one criterion that excludes user intervention for refreshing the passwords to the remote systems. The trigger may include, e.g., a time indication, elapsed period of time, login indications, or a network trigger. For example, passwords may expire after a set period of time and trigger automatic generation of new passwords. For example, passwords may expire after a password has been used for a certain number of times or a number of login uses. In another example, the trigger may be a network trigger (e.g., a network message from another system) that indicates to generate a new set of passwords. The network trigger may be used in instances of security events such as network breaches or other network intrusions or compromises. If any part of a network is compromised, some network message may trigger generation of new passwords.

At step 240, the system may generate a new set of passwords and transmit at least one command including the new set of passwords to the remote systems. For example, the system may generate passwords based on one or more algorithms for the online services. For example, some online services may request alphanumeric passwords. Some online services may request hashes associated with biometric readings. Some online services may request security tokens such as a cryptographic key, a digital signature, biometric data (e.g., fingerprint, eye scan, etc.), etc. A security token may include static password tokens, synchronous dynamic password tokens, asynchronous password tokens, or challenge-response tokens. When a token may be requested, the system may proceed with or without user intervention. For example, in the case of requests for tokens without user intervention, a separate user device may have stored security tokens retrievable without user intervention. In another example, the system itself may be configured to store security tokens (e.g., in a storage such as data storage 120 or a memory within or coupled to the system) for use in generating passwords.

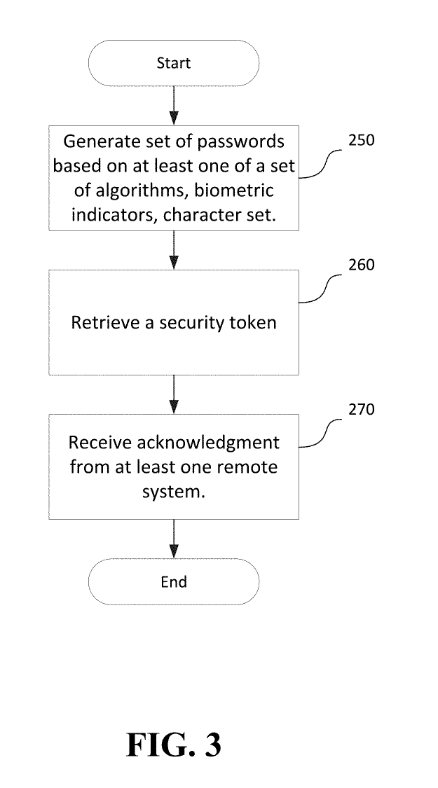

FIG. 3 is a flowchart of another exemplary embodiment. The method in FIG. 3 may be performed by a computing system, such as computing system 101. The methods in FIG. 3 may be methods of password management module 103. Although the steps in FIG. 3 are shown in sequence, the steps may be performed in any order, and any or all steps may be performed while omitting any of the other steps. Starting at 250, the system may generate a set of passwords based on at least one set of algorithms, a set of biometric indicators, or a set of enumerated character set. Proceeding to step 260, the system may retrieve a security token associated with the user or a set of biometric readings associated with the user. For example, the system may retrieve the security token from another user device or another system that has the security token. In another example, the system itself may be configured to store the security token. In any case, the security token may be retrieved without user intervention. Proceeding to step 270, the system may receive an acknowledgment from at least one of the remote systems. The acknowledgement may be a message indicating either success or failure of updating a password associated with the user. In case of receipt of a failure message, the system may make an additional attempt to generate and send another password.

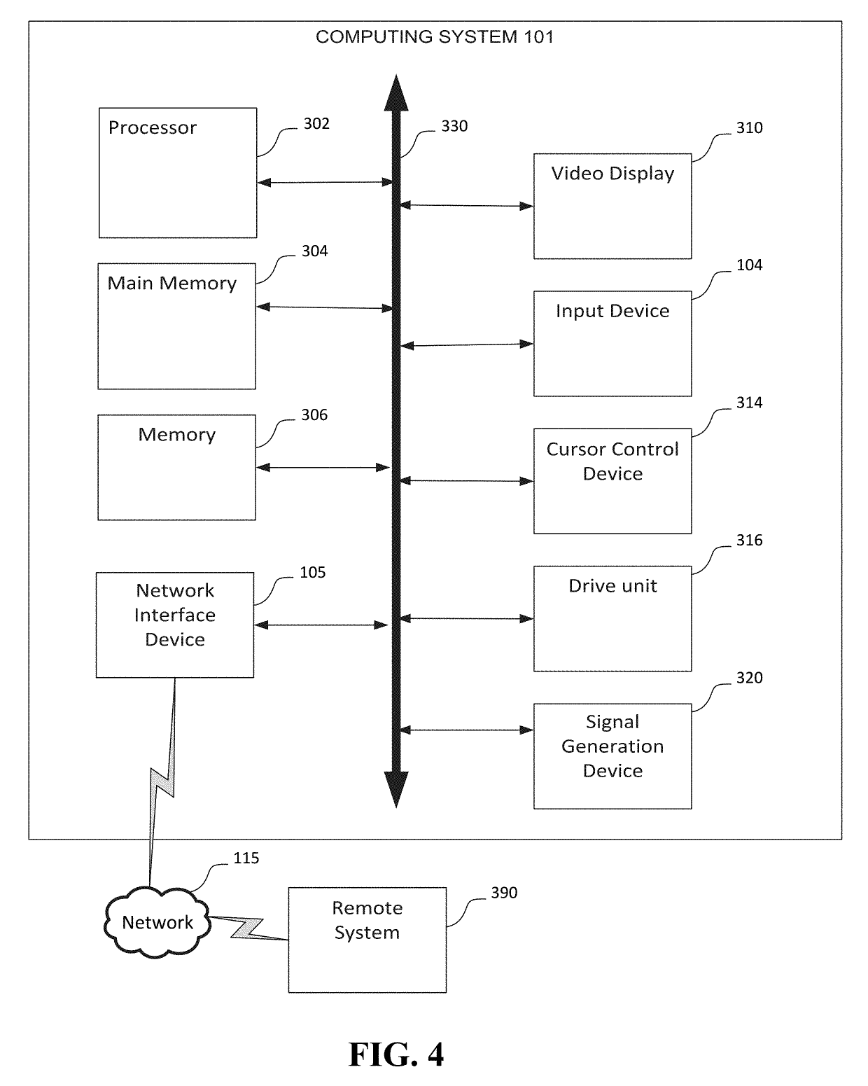

FIG. 4 illustrates a diagrammatic representation of a machine in the exemplary form of a computer system 101 within which a set of instructions, for causing the machine to perform any one or more of the methodologies discussed herein, may be executed. In alternative embodiments, the machine may be connected (e.g., networked) to other machines in a Local Area Network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a laptop computer, a table device, a mobile device, a wearable device, or any machine capable of executing a set of instructions (sequentially or otherwise) that specify actions to be taken by that machine. Further, while only a single machine is illustrated, the term “machine” may also be taken to include any collection of machines (e.g., computers) that individually or jointly execute a set (or multiple sets) of instructions to perform any one or more of the methodologies discussed herein.

The exemplary computer system 101 may include a processor 302, a main memory 304 (e.g., read-only memory (Rom), a flash memory, dynamic random access memory (DRAM) such as synchronous DRAM (SDRAM), etc.), a static memory 306 (e.g., flash memory, static random access memory (SRAM), etc.), and a secondary memory 316 (e.g., a data storage device), which communicate with each other via a bus 330.

The processor 302 may represent one or more general-purpose processing devices such as a microprocessor, central processor unit, or the like. More particularly, the processor 302 may be a complex instruction set computing (CISC) microprocessor, reduced instruction set computing (RISC) microprocessor, very long instruction word (VLIW) microprocessor, processor implementing other instruction sets, or processors implementing a combination of instruction sets. The processor 302 may also be one or more special-purpose processing devices such as an application specific integrated circuit (ASIC), a field programmable gate array (FPGA), a digital signal processor (DSP), network processor, or the like. The processor 302 is configured to execute password management module 103 for performing the operations and steps discussed herein (e.g., steps of FIG. 2 and FIG. 3).

The computer system 101 may further include a network interface device 105. The network interface device 105 may be in communication with a network 115. The computer system 101 also may include a video display unit 310 (e.g., a liquid crystal display (LCD), a cathode ray tube (CRT), plasma display, organic light emitting diode (OLED)), an alphanumeric input device 104 (e.g., a keyboard), a cursor control device 314 (e.g., a mouse), and a signal generation device 320 (e.g., a speaker).

The second memory 316 may include a computer-readable storage medium (or more specifically a computer-readable storage medium) on which is stored one or more sets of instructions for password management module 103 embodying any one of more of the methodologies or functions described herein. The instructions of the password management module 103 may also reside, completely or at least partially, within the main memory 304 and/or within the processing device 302 during execution thereof by the computer system 101, the main memory 304 and the processing device 302 also constituting computer-readable storage media. The instructions of the password management module 103 may further be transmitted or received over a network via the network interface device 105. The network interface device 105 may be configured to communicate with one or more remote systems 390 via network 105.

While the computer-readable storage medium 316 is shown in an exemplary embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” may also be taken to include any medium that is capable of storing or encoding a set of instructions for execution by the machine that cause the machine to perform any one or more of the methodologies of the present disclosure. The term “computer-readable storage medium” may accordingly be taken to include, but not limited to, solid-state memories (e.g., solid state drive (SSD), solid state module (SSM), etc), and optical and magnetic media.

Some portions of the detailed descriptions above may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proved convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “receiving,” “authenticating,” “storing,” “detecting,” “retrieving,” “granting,” “performing,” “locking,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of the present invention also relate to an apparatus for performing the operations herein. This apparatus may be specifically constructed for the required purposes, or it may be general purpose computer system selectively programmed by a computer program stored in the computer system. Such a computer program may be stored in a computer readable storage medium, such as, but not limited to, any type of disk including optical disks, CD-ROMs, DVD-ROMs, Blu-ray disks, magnetic-optical disks, read-only memories (ROMs), random access memories (RAMs), EPROMs, EEPROMs, magnetic-optical disk storage media, optical storage media, flash memory devices, solid state devices, other type of machine-accessible storage media, or any type of media suitable for storing electronic instructions, each coupled to a computer system bus.

The algorithms and displays presented herein are not inherently related to any particular computer or other apparatus. Various general purpose systems may be used with programs in accordance with the teachings herein, or it may prove convenient to construct a more specialized apparatus to perform the required method steps. The required structure for a variety of these systems will appear as set forth in the description below. In addition, the present disclosure is not described with reference to any particular programming language. It will be appreciated that a variety of programming languages may be used to implement the teachings of the disclosure as described herein.

It is to be understood that the above description is intended to be illustrative, and not restrictive. Many other embodiments will be apparent to those of skill in the art upon reading and understanding the above description. Although the present disclosure has been described with reference to specific exemplary embodiments, it will be recognized that the disclosure is not limited to the embodiments described, but can be practiced with modification and alteration within the spirit and scope of the appended claims. Accordingly, the specification and drawings are to be regarded in an illustrative sense rather than a restrictive sense. The scope of the invention should, therefore, be determined with reference to the appended claims, along with the full scope of equivalents to which such claims are entitled.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method for automatically refreshing passwords associated with a user of a set of remote systems, the method comprising:
determining a set of current passwords associated with the user of the remote systems;
determining at least one criterion that excludes user intervention for refreshing passwords to the remote systems;
detecting at least one trigger condition matching at least one criterion that excludes user intervention for refreshing the passwords to the remote systems; and
upon detecting the at least one trigger condition, generating a new set of passwords and transmitting at least one command including the new set of passwords to the remote systems.

2. The method of claim 1, wherein the at least one trigger condition includes at least one of a time elapsed, a system indication, or external system indication of a security event.

3. The method of claim 1, wherein the generating comprises generating based on at least one set of algorithms, a set of biometric indicators, or a set of enumerated character set.

4. The method of claim 1, wherein the generating comprises retrieving a security token associated with the user or a set of biometric readings associated with the user.

5. The method of claim 1, further comprising receiving an acknowledgment from at least one of the remote systems.

6. The method of claim 1, wherein the remote systems comprises at least one of a authentication, authorization, and accounting (AAA) server, a terminal access controller access control system plus server (TACACS+), or remote authentication dial-in user service (RADIUS) server.

7. An apparatus for automatically refreshing passwords associated with a user of a set of remote systems, comprising:
means for determining a set of current passwords associated with the user of the remote systems;
means for determining at least one criterion that excludes user intervention for refreshing passwords to the remote systems;
means for detecting at least one trigger condition matching at least one criterion that excludes user intervention for refreshing the passwords to the remote systems; and
means for generating a new set of passwords and transmitting at least one command including the new set of passwords to the remote systems upon detecting the at least one trigger condition.

8. An apparatus for automatically refreshing passwords associated with a user of a set of remote systems, comprising:
at least one processor configured for:
determining a set of current passwords associated with the user of the remote systems,
determining at least one criterion that excludes user intervention for refreshing passwords to the remote systems,
detecting at least one trigger condition matching at least one criterion that excludes user intervention for refreshing the passwords to the remote systems, and
upon detecting the at least one trigger condition, generating a new set of passwords and transmitting at least one command including the new set of passwords to the remote systems; and
a memory coupled to the at least one processor for storing data.

8. The apparatus of claim 7, further comprising at least one transceiver configured for receiving an acknowledgment from at least one of the remote systems.

9. A computer program product automatically refreshing passwords associated with a user of a set of remote systems, comprising:
a computer-readable medium comprising code for:
determining a set of current passwords associated with the user of the remote systems;
determining at least one criterion that excludes user intervention for refreshing passwords to the remote systems;
detecting at least one trigger condition matching at least one criterion that excludes user intervention for refreshing the passwords to the remote systems; and
upon detecting the at least one trigger condition, generating a new set of passwords and transmitting at least one command including the new set of passwords to the remote systems.
